(19) United States
(12) Patent Application Publication
(10) Pub. No.: US 2006/0287214 A1
(43) Pub. Date: Dec. 21, 2006

(54) Detergent that can be used as a fire extinguisher

(76) Inventors: Ching-Huan Lin, Tali City (TW); Roscow Lin, Tali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/156,643

(22) Filed: Jun. 21, 2005

(51) Int. Cl. C11D 17/00

(52) U.S. Cl. 510/438

(57) ABSTRACT

A detergent practical for cleaning things as well as for extinguishing a fire is disclosed to contain a retardant, a surfactant, a thickener, and sterilizing water.

### BACKGROUND OF THE INVENTION

1. Field of the Invention

The present invention relates to detergent and more particularly, to such a detergent that can be used as a fire extinguisher.

2. Description of the Related Art

Regular detergents commonly use a surfactant (soap in liquid). These detergents are simply prepared for cleaning things. There are detergents prepared by mixing a surfactant with a flammable solvent. These detergents are suitable for removing oil dirt, but fail to be used as extinguisher.

Further, conventional fire extinguishers are commonly prepared from a foam material and filled with a compressed non-flammable gas in a steel cylinder. The foam material contains water. The non-flammable gas can be HFC-227, chlorodifluoromethane, trifluoroethane, tetrafluoroethane, carbon dioxide. Conventional fire extinguishers are toxic and not usable for cleaning things, and have a short expiring date. When expired, the fire extinguishers must be reclaimed and properly disposed of.

### SUMMARY OF THE INVENTION

The present invention has been accomplished under the circumstances in view. It is the main object of the present invention to provide a detergent, which is practical for cleaning things as well as extinguishing a fire. To achieve this and other objects of the present invention, the detergent comprises a retardant, a surfactant, a thickener, and sterilizing water. Further, the detergent is contained with compressed nitrogen gas in a pressure-resisting container having a spray nozzle.

### BRIEF DESCRIPTION OF THE DRAWINGS

FIG. 1 is a block diagram of the present invention.

### DETAILED DESCRIPTION OF THE PREFERRED EMBODIMENT

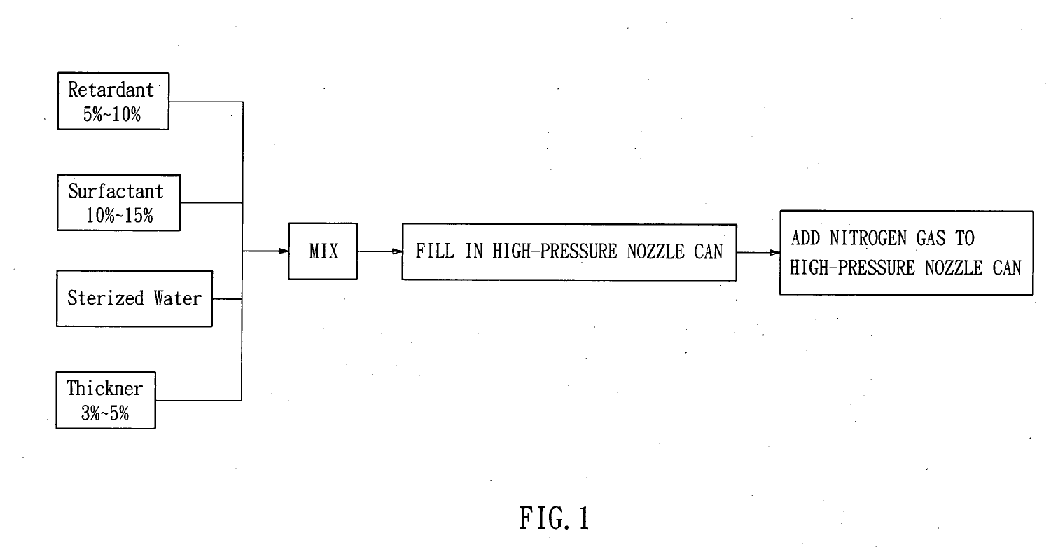

Referring to FIG. 1, a detergent in accordance with the present invention contains a retardant, a surfactant, a thickener, and sterilizing water. After well mixing of the prepared retardant, surfactant, thickener, and sterilizing water, the mixture (detergent) with pressed nitrogen is filled in a pressure-resisting container.

In one example of the present invention, 5%˜10% retardant is mixed with 10%˜15% surfactant and 3%˜5% thickener, and a certain amount of sterilizing water to make 100%. All the compositions are calculated by volume. The mixture thus obtained is filled into a pressure-resisting container that has a spray nozzle. The mixture occupies only 60%˜70% of the volume (holding space) of the container. Thereafter, nitrogen gas is forced with a high pressure into the container to fill up the whole inside space of the container. When the user pressed the control button of the spray nozzle of the container, the detergent with other ingredients are sprayed out of the spray nozzle.

The retardant is a polyphosphate compound soluble in water. The sterilizing water is prepared by mixing a sterilizing agent with pure water. The surfactant is a non-toxic, non-solvent type water soluble compound.

When sprayed the detergent over a burning object, the retardant retarding the burning of the object and isolating contact of the burning object from air, thereby extinguishing the fire.

The surfactant is non-flammable, and can produce foams to desorb oil dirt. When used to extinguish a fire, the surfactant masks oil and produce foams to thicken the retardant, enhancing the power of the retardant to isolate the object from air and lowering flammability of oil. When used to clean things, the surfactant is effective to remove oil and dirt from an object.

The sterilizing water allows mixing of the retardant with the surfactant evenly. The sterilizing agent contained in the sterilizing water keeps the detergent from deterioration and can sterilize the object been cleaned with the detergent.

The thickener is non-hydrophobic and non-flammable, adapted to make the mixture of the retardant and the surfactant into a foam-like status for covering over the flame to retard the flame.

The use of nitrogen is to increase the inside pressure of the container. Because nitrogen is non-flammable, it can be used to extinguish a fire without polluting the environment.

As indicated above, the present invention provides a detergent, which is prepared in a container having a spray nozzle convenient for use in the bathroom, kitchen, or other places to be regularly cleaned. Because the detergent contains a water soluble retardant of polyphosphate compound and a surfactant, practical for cleaning tiles, kitchen sinks, dishes, exhaust hoods, furniture, floor plates, etc. Further, because the invention is contained with compressed nitrogen in a pressure-resisting container having a spray nozzle, it is also practical for use as a fire extinguisher.

In a test, 1 liter of salad oil was put in an oil pan of radius 30 cm and burned to about 400° C., and then 500 cc of the detergent prepared according to the present invention was sprayed over the flame. The flame was weakened significantly and completely extinguished about 8 seconds after spray (see the annexed pictures).

Further, if the detergent has been kept for no use for a length of timer over the expiring date of the retardant, the detergent is ineffective for extinguishing a fire, however it can still be used for cleaning things.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A detergent made by mixing a retardant, a surfactant, a thickener, and water subject to a predetermined ratio, which can present dual functions, being used not only as cleanser, but also as fire extinguisher; said retardant and said surfactant and said thickener being non-flammable, non-solvent and water soluble compounds ; said surfactant being adapted to desorb oil dirt and to produce foam for cleaning, said retardant being adapted to retarding a fire, said thickener being adapted to maintain the foam produced by said surfactant and said retardant and to further enhance adherence of the foam to the flame of the fire, isolating the flame from contacting the air, and finally extinguishing fire.

2. The detergent as claimed in claim 1, wherein said retardant is obtained from non-toxic water soluble polyphosphate containing 15%˜10% by volume; said surfactant includes positive, negative, amphoteric, and non-ionic surfactant structures, containing 10%˜15% by volume, said thickener includes positive, negative, amphoteric, and non-ionic polymers of viscous characteristic, containing 3%˜5% by volume, and said water is the balance to make 100%.

3. The detergent as claimed in claim 1, wherein said water is a sterilizing water containing a sterilizing agent.

4. The detergent as claimed in claim 1, which is contained with compressed nitrogen gas in a pressure-resisting container having a spray nozzle.

5. The detergent as claimed in claim 1, should provide dual functions both as cleanser and fire extinguisher, when demonstrate by pressing spray nozzle through the compacted nitrogen-pressed container.
